(19) United States
(12) Patent Application Publication
(10) Pub. No.: US 2007/0065656 A1
(43) Pub. Date: Mar. 22, 2007

(54) Method for improving adhesion between a substrate and a coating

(76) Inventors: Anthony M. Chasser, Allison Park, PA (US); Shawn P. Duffy, Cheswick, PA (US)

Correspondence Address: PPG Industries, Inc.;Law Department, One PPG Place, Pittsburgh, PA, 15272, US

(21) Appl. No.: 11/231,733

(22) Filed: Sep. 21, 2005

(51) Int. Cl. B32B 9/00

(52) U.S. Cl. 428/318.4; 428/319.3; 428/319.7

(57) ABSTRACT

Methods for improving adhesion between a substrate and coating comprising exposing the substrate to actinic radiation prior to applying the coating are disclosed; substrates coated in this manner are also disclosed.

### FIELD OF THE INVENTION

The present invention is directed to methods for improving adhesion between a substrate and a coating comprising exposing the substrate to actinic radiation prior to applying the coating.

### BACKGROUND OF THE INVENTION

Many substrates have applied thereto one or more coatings, which typically serve a decorative and/or protective function. Such coatings may flake, crack, or otherwise be removed from the substrate as a result of time, chemical exposure, mechanical stresses and the like. This is particularly true of flexible substrates. Improved adhesion between substrates and coatings is therefore desired.

### SUMMARY OF THE INVENTION

The present invention provides methods for improving adhesion between a substrate and a coating comprising exposing the substrate to actinic radiation prior to applying the coating.

### DETAILED DESCRIPTION OF THE INVENTION

The present invention is directed to methods for improving adhesion between a substrate and a coating comprising exposing the substrate to actinic radiation prior to applying the coating. “Actinic radiation” and like terms include, for example, electron beam (“EB”) radiation and ultraviolet (“UV”) radiation.

Substrates treated according to the present invention can include, for example, flexible substrates. As used herein, “flexible substrate” and like terms refer to substrates that can undergo mechanical stresses, such as bending or stretching and the like, without significant irreversible change. In certain embodiments, the flexible substrates are compressible substrates. “Compressible substrate” and like terms refer to substrates capable of undergoing a compressive deformation and returning to substantially the same shape once the compressive deformation has ceased. The term “compressive deformation” means a mechanical stress that reduces the volume at least temporarily of a substrate in at least one direction. Examples of flexible substrates include non-rigid substrates, such as thermoplastic urethane (TPU), synthetic leather, natural leather, finished natural leather, finished synthetic leather, foam, including but not limited to, polyolefins and polyolefin blends, polyvinyl acetate and copolymers, polyvinyl chloride and copolymers, polymeric bladders filled with air, liquid, and/or plasma, urethane elastomers, synthetic textiles and natural textiles. “Foam” can be a polymeric or natural material comprising open cell foam and/or closed cell foam. “Open cell foam” means that the foam comprises a plurality of interconnected air chambers; “closed cell foam” means that the foam comprises discrete closed pores. Example foams include but are not limited to polystyrene foams, poly(meth)acrylamide foams, polyvinylchloride foams, polyurethane foams, and polyolefinic foams. Polyolefinic foams include but are not limited to polypropylene. foams, polyethylene foams and ethylene vinyl acetate (“EVA”) foams. EVA foam can include flat sheets or slabs or molded EVA foams, such as shoe midsoles. Different types of EVA foam can have different types of surface porosity. Molded EVA can comprise a dense surface or “skin”, whereas flat sheets or slabs can exhibit a porous surface. “Textiles” can include fabric, mesh, netting, cord, and the like, and can be comprised of canvas, nylon, cotton, polyester, and others.

As noted above, the substrate is exposed to actinic radiation prior to applying the coating. The exposure can be at the dosage necessary to induce the desired level of improved adhesion. Typically, a dosage of 0.1 to 10 Joules/cm², such as 1 to 5, or 3 Joules/cm² with an irradiance of 5 mW/cm² to 10 W/cm², such as 50 mW/cm² to 2 W/cm², or 200 mW/cm² to 500 mW/cm², will be sufficient. In certain embodiments, treatment according to the present invention eliminates the need for a primer, such as a liquid primer, to be applied prior to coating.

Exposure to actinic radiation can be achieved in any manner known in the art, such as a UV lamp. Various bulbs and wavelengths can be used, such as H+ (210-320 nm), H (240-320 nm), D (350-400 nm), V (400-450 nm), and/or Q (430-470 nm) bulbs. In certain embodiments, the substrate or portion thereof that is exposed to actinic radiation (“exposed substrate”) is uncoated; a coating is then applied to at least a portion of the exposed substrate. In other embodiments, the substrate may comprise one or more coatings prior to actinic radiation exposure. Exposure of an already coated substrate to actinic radiation improves adhesion between the existing coating on the substrate and the subsequently applied coating. Thus, “substrate” and like terms is used herein to refer to a coated or uncoated substrate.

It is believed that the surface of the substrate, whether it is coated or uncoated, actually changes upon exposure to actinic radiation; more specifically, functional groups possessing oxygen will actually be present on the surface of the substrate after the exposure. These functional groups are not present, or are not present in any significant quantity, before exposure, however. The functional groups may result from a breakdown, degradation, or other reaction at the surface of the substrate promoted by the exposure to actinic radiation. Examples of these functional groups include but are not limited to carbonyl groups, carbinol groups, esters, ketone, acid and aldehyde groups. Regardless of the substrate, the enrichment in functional groups possessing oxygen is demonstratable. The inventors do not wish to be bound by any of these mechanisms, however.

As a result of the exposure to actinic radiation and presence of functional groups at the surface of the substrate, these functional groups can then covalently link with functional groups in a coating. Additionally, surface polarity of a substrate can increase significantly, such as up to 10 dynes/cm, after exposure, as shown in Table 1.

TABLE 1

| | Dynes/cm |
|---|---|
| Untreated EVA | 35 |
| EVA treated with 3 Joules of UV radiation | 43 |
| Untreated TPU | 44 |
| TPU treated with 3 Joules of UV radiation | 50 |

This observation is consistent with increasing polar moieties, such as acids or carbonyl groups. As such, enhanced adhesion mechanisms may contribute to an improved adhesion. Again, the inventors do not wish to be bound by this mechanism. Because of the covalent bonding and/or enhanced adhesion mechanisms, virtually any coating can be used according to the present invention. Particularly suitable coatings are those comprising grafted polyolefins. It may be desired to “match” the coating with the substrate. For example, in certain embodiments, coatings used according to the present invention may exhibit flexibility such that they are suitable for application onto flexible substrates.

The flexible coatings and substrates used in certain embodiments of the present invention have a wide variety of applications. For example, the coated flexible substrates can be part of sporting equipment or apparel, such as athletic shoes, balls, bags, clothing and the like; an automotive interior component; a motorcycle component; household furnishings and decorations and the like.

Various additives standard in the art can be used in the coatings used in accordance with the present invention.

Such additives can include, for example, texture-enhancing additives such as silica or a paraffin wax to improve the surface feel of the coating and to enhance stain resistance. Other suitable additives can include those standard in the art, including but not limited to plasticizers, leveling agents, adhesion promoters, colorants, rheology modifiers, ultra-violet (UV) absorbers, and hindered amine light stabilizers (HALS).

The coatings used according to the present invention may also include a colorant. As used herein, the term “colorant” means any substance that imparts color and/or other opacity and/or other visual effect to the composition. The colorant can be added to the coating in any suitable form, such as discrete particles, dispersions, solutions and/or flakes. A single colorant or a mixture of two or more colorants can be used in the coating used according to the present invention.

Example colorants include pigments, dyes and tints, such as those used in the paint industry and/or listed in the Dry Color Manufacturers Association (DCMA) as well as special effect compositions. A colorant may include, for example, a finely divided solid powder that is insoluble but wettable under the conditions of use. A colorant can be organic or inorganic and can be agglomerated or non-agglomerated.

Example pigments and/or pigment compositions include, but are not limited to, carbazole dioxazine crude pigment, azo, monoazo, disazo, naphthol AS, salt type (lakes), benzimidazolone, condensation, metal complex, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), titanium dioxide, carbon black and mixtures thereof. The terms “pigment” and “colored filler” can be used interchangeably.

Example dyes include, but are not limited to, those that are solvent and/or aqueous based such as pthalo green or blue, iron oxide, bismuth vanadate, anthraquinone, perylene, aluminum and quinacridone.

Example tints include, but are not limited to, pigments dispersed in water-based or water miscible carriers such as AQUA-CHEM 896 commercially available from Degussa, Inc., CHARISMA COLORANTS and MAXITONER INDUSTRIAL COLORANTS commercially available from Accurate Dispersions, division of Eastman Chemical, Inc.

As noted above the colorant can be in the form of a dispersion including, but not limited to, a nanoparticle dispersion. Nanoparticle dispersions can include one or more highly dispersed nanoparticle colorants or colorant particles that produce a desired visible color and/or opacity and/or visual effect. Nanoparticle dispersions can include colorants such as pigments or dyes having a particle size of less than about 150 nm, such as less than 70 nm, or less than 30 nm. Nanoparticles can be produced by milling stock organic or inorganic pigments with grinding media having a particle size of less than 0.5 mm. Example nanoparticle dispersions and methods for making them are identified in U.S. Pat. No. 6,875,800 B2, which is incorporated herein by reference. Nanoparticle dispersions can also be produced by crystallization, precipitation, gas phase condensation, and chemical attrition (i.e., partial dissolution). In order to minimize re-agglomeration of nanoparticles within the coating, a dispersion of resin-coated nanoparticles can be used. As used herein, a “dispersion of resin-coated nanoparticles” refers to a continuous phase in which is dispersed discreet “composite microparticles” that comprise a nanoparticle and a resin coating on the nanoparticle. Example dispersions of resin-coated nanoparticles and methods for making them are identified in U.S. Serial application Ser. No. 10/876,315 filed Jun. 24, 2004, which is incorporated herein by reference, and U.S. Provisional Application No. 60/482,167 filed Jun. 24, 2003, which is also incorporated herein by reference.

Example special effect compositions that may be used include pigments and/or compositions that produce one or more appearance effects such as reflectance, pearlescence, metallic sheen, phosphorescence, fluorescence, photochromism, photosensitivity, thermochromism, goniochromism and/or color-change. Additional special effect compositions can provide other perceptible properties, such as opacity or texture. In a non-limiting embodiment, special effect compositions can produce a color shift, such that the color of the coating changes when the coating is viewed at different angles. Example color effect compositions are identified in U.S. Patent Application Publication No. 2003/0125416, incorporated herein by reference. Additional color effect compositions can include transparent coated mica and/or synthetic mica, coated silica, coated alumina, a transparent liquid crystal pigment, a liquid crystal coating, and/or any composition wherein interference results from a refractive index differential within the material and not because of the refractive index differential between the surface of the material and the air.

In certain non-limiting embodiments, a photosensitive composition and/or photochromic composition, which reversibly alters its color when exposed to one or more light sources, can be used. Photochromic and/or photosensitive compositions can be activated by exposure to radiation of a specified wavelength. When the composition becomes excited, the molecular structure is changed and the altered structure exhibits a new color that is different from the original color of the composition. When the exposure to radiation is removed, the photochromic and/or photosensitive composition can return to a state of rest, in which the original color of the composition returns. In one non-limiting embodiment, the photochromic and/or photosensitive composition can be colorless in a non-excited state and exhibit a color in an excited state. Full color-change can appear within milliseconds to several minutes, such as from 20 seconds to 60 seconds. Example photochromic and/or photosensitive compositions include photochromic dyes.

In a non-limiting embodiment, the photosensitive composition and/or photochromic composition can be associated with and/or at least partially bound to, such as by covalent bonding, a polymer and/or polymeric materials of a polymerizable component. In contrast to some coatings in which the photosensitive composition may migrate out of the coating and crystallize into the substrate, the photosensitive composition and/or photochromic composition associated with and/or at least partially bound to a polymer and/or polymerizable component in accordance with a non-limiting embodiment of the present invention have minimal migration out of the coating. Example photosensitive compositions and/or photochromic compositions and methods for making them are identified in U.S. application Ser. No. 10/892,919 filed Jul. 16, 2004 and incorporated herein by reference.

In general, the colorant can be present in the coating composition in any amount sufficient to impart the desired visual and/or color effect. The colorant may comprise from 1 to 65 weight percent of the present compositions, such as from 3 to 40 weight percent or 5 to 35 weight percent, with weight percent based on the total weight of the compositions.

The present invention is further directed to a coated substrate comprising a) a substrate that has been exposed to actinic radiation; and b) a coating applied to at least a portion of the exposed substrate of a). The substrate and coating can be any of the substrates and coatings described above; similarly, the exposure to actinic radiation can be as described above. All or part of the substrate can be exposed to actinic radiation and all or part of the exposed substrate can be coated; at least part of the coating will be applied to at least part of the exposed substrate. “A substrate that has been exposed to actinic radiation”, “exposed substrate”, and like terms mean exposing any portion of the substrate to actinic radiation. The coating can be applied to at least a portion of the substrate, including the exposed substrate, by any manner known in the art, such as brushing, spraying, rolling, roll coating, slot coating or dipping. The coatings can be cured by any manner known in the art; one can determine the appropriate cure conditions based upon the type of coating used and the substrate, if relevant.

As used herein, unless otherwise expressly specified, all numbers such as those expressing values, ranges, amounts or percentages may be read as if prefaced by the word “about”, even if the term does not expressly appear. Any numerical range recited herein is intended to include all sub-ranges subsumed therein. Plural encompasses singular and vice versa. For example, while the invention has been described in terms of “a” coating, more than one coating can be used. Also, as used herein, the term “polymer” is meant to refer to prepolymers, oligomers and both homopolymers and copolymers; the prefix “poly” refers to two or more.

### EXAMPLES

The following examples are intended to illustrate the invention, and should not be construed as limiting the invention in any way.

### Example 1

Two standard urethane 2K systems were evaluated for adhesion to a variety of substrates.

XPM 61626S—A navy blue paint, commercially available from PPG Industries, Inc.

DCU 2021—2K Clear, commercially available from PPG Industries, Inc.

| | XPM | DCU |
|---|---|---|
| | 61626S | 2021 |
| Adhesion of subsequent coating (“Recoat”) | 3B | 3B |
| to an already coated EVA substrate | | |
| Adhesion of standard footwear glue “72 KMN” | 0B | 0B |
| to uncoated EVA | | |
| Adhesion to uncoated EVA | 0B | 0B |
| Recoat adhesion after 3 Joules of UV radiation | 5B | 5B |
| Glue adhesion after 3 Joules of UV radiation | 5B | 5B |
| EVA adhesion after 3 Joules of UV radiation | 5B | 5B |

0-5 adhesion rating is according to ASTM D3359 and is a visual adhesion rating;

this test is standard in the coatings industry:

| | |
|---|---|
| 0B | little or no adhesion |
| 1B | 20% adhesion |
| 2B | 40% adhesion |
| 3B | 60% adhesion |
| 4B | 80% adhesion |
| 5B | 100% adhesion |

The 72 KMN glue is a standard 2K polyurethane adhesive used in the footwear industry.
UV radiation performed with standard Hg lamps running in the QUV A spectrum with a dosing of 300 milliwatts/cm². Total dosage measure in Joules.

Whereas particular embodiments of this invention have been described above for purposes of illustration, it will be evident to those skilled in the art that numerous variations of the details of the present invention may be made without departing from the invention as defined in the appended claims.

What is claimed is:

1. A method for improving adhesion between a substrate and a coating comprising exposing the substrate to actinic radiation prior to applying the coating.

2. The method of claim 1, wherein the actinic radiation is UV radiation.

3. The method of claim 1, wherein the exposure is 1 to 5 Joules/cm² at an irradiance of 50 mW/cm² to 2 mW/cm².

4. The method of claim 3, wherein the exposure is 3 Joules/cm² at an irradiance of 200 mW/cm² to 500 mW/cm².

5. The method of claim 1, wherein the substrate is a flexible substrate.

6. The method of claim 5, wherein the substrate is compressible.

7. The method of claim 6, wherein the substrate is EVA foam.

8. The method of claim 1, wherein the coating comprises a urethane.

9. The method of claim 1, wherein the coating comprises a grafted polyolefin.

10. A coated substrate comprising:
(a) a substrate that has been at least partially exposed to actinic radiation; and
(b) a coating applied to at least a portion of the exposed substrate of (a).

11. The substrate of claim 10, wherein the actinic radiation is UV radiation.

12. The substrate of claim 10, wherein the exposure is 1 to 5 Joules/cm² at an irradiance of 50 mW/cm² to 2 W/cm².

13. The substrate of claim 12, wherein the exposure is 3 Joules/cm² at an irradiance of 200 mW/cm² to 500 mW/cm².

14. The substrate of claim 10, wherein the substrate is a flexible substrate.

15. The substrate of claim 14, wherein the substrate is compressible.

16. The substrate of claim 15, wherein the substrate is EVA foam.

17. The substrate of claim 10, wherein the coating comprises a urethane.

18. The substrate of claim 10, wherein the coating comprises a grafted polyolefin.

19. The substrate of claim 10, wherein the substrate is at least partially coated before exposure.
